(19) United States
(12) Patent Application Publication
(10) Pub. No.: US 2022/0077701 A1
(43) Pub. Date: Mar. 10, 2022

(54) Universal Mobile Device Charging Station

(71) Applicant: Jakko H. Yang, Pleasanton, CA (US)

(72) Inventor: Jakko H. Yang, Pleasanton, CA (US)

(21) Appl. No.: 17/014,989

(22) Filed: Sep. 8, 2020

(51) Int. Cl. H02J 7/00; H02J 7/02

(52) U.S. Cl. CPC H02J 7/0045; H02J 7/02

(57) ABSTRACT

A publicly accessible universal charging station for mobile phone, tablet, laptop and other portable devices is presented. The charging station includes an electrical cord for power source, a main housing, multiple sets of device support and multiple power outlet receptacles. The housing has one or multiple facing-up slope surfaces. Power outlet receptacles are through the combination geometry configuration outlet receptacles that are to electro-mechanically engage plugs with configurations for various major or even all countries in the world for global use. The power outlet receptacles are provided within the housing for receiving multiple mobile devices to be simultaneously charged. USB power outlet receptacle can also be included. Individual receptacle is located on the facing-up slope surface of housing. In use, the charging station would support globally 110 VAC up to 240 VAC, 50 Hz or 60 Hz regular power source.

### FIELD OF THE INVENTION

The present invention relates to chargers for general portable electronic devices, and particularly to a mobile device charging station that provides a way for publicly accessible universal charging.

### BACKGROUND OF THE INVENTION

Portable electronic devices, particularly smart phones, are widely used now. Due to nature of portability and limited energy a battery can carry, recharge of battery is always needed in foreseeable future.

Electronic device users often employ a spare auxiliary battery to replace the original device battery in the event of battery discharge or failure. If an auxiliary battery is not available, the device with the discharged battery must be recharged with an exterior charger or hands-free vehicle kit charger. But for some reasons, few device users carry auxiliary batteries. Thus, recharging of the primary battery is the only option for maintaining proper power levels for operation of the device. Therefore, a public mobile device charging station solving the aforementioned problems is desired.

In addition, of course, people want that charging is free everywhere at airport, train station, bus station, stadium, sports complex, general waiting room etc.

There are multiple prior arts for charging stations. However, those prior arts have disadvantages.

The first disadvantage is that some charging stations are indeed fee oriented. In modern world, a lot of energy is from renewable energy like solar and wind energy. In most cases, people do not want to pay just for cell phone charging.

The second disadvantage is that regular outlet receptacle will get loose after frequent uses and cannot hold charger plugs anymore. Most of charger outlet receptacles are located at a vertical wall. After hundreds of thousands times of plug-in & out use, plugs can no longer stay engaged with outlet receptacles and will fall out under gravity. So far there is no solution to prevent outlet receptacles from getting loose after frequent uses.

The third disadvantage is that the USB outlet receptacles will not last very long. A standard USB connector has a polarity. Even at desktop and laptop computer, people would have to make sure that USB outlet receptacles match device plugs. People usually double-check polarity of both sides before plugging in. The USB connectors in prior art are at vertical wall and very difficult to check connector polarities. If people cannot see well they then will assume correctness and use brutal force in a hurry. Damaged USB connectors at pubic place charging stations are widespread problems.

The fourth disadvantage is that there are too many device and wire interferences. In prior arts, charging wire from one mobile device gets tangled with another wire from another mobile device is very common problem.

The fifth disadvantage is that it is hard to identify vacancy or charging spots in a distance. In most cases, users never know how many vacancies left in a charging station until users come closer to check.

The sixth disadvantage is limited capacity. Most charging station can charge several mobile devices at the same time. It is not enough. It would be much better if a charging station could charge tens of mobile devices at the same time. Assume each device have 20 W charging power, then a standard 110 VAC, 10 A power can support more than 40 devices.

The seventh disadvantage is that it is not universal. There are more than ten different power outlet receptacle configurations in the world. Existing charging station products in existing market can only support specific group of countries.

The eighth disadvantage is that it is hard to locate charger itself. Usually people will not know there is a charging station nearby until they see the power outlet receptacles. It is understandable that device charging functionality would need to somehow incorporate into some public-accepted appearance.

The ninth disadvantage is that efficiency is low. Power outlet receptacles are usually closely next to each other. User is unwilling to use even there are vacancies in fear of bothering others.

To solve problems in prior arts, Current invention would have following advantages.

The first advantage is that the current invention is intended to let people to charge their mobile device for free just like that in major international airports.

The second advantage is that power outlet receptacles would have a very long utility lifespan. Regular power outlet receptacles are located at one or multiple facing-up slope surface. Even after tens of thousands of uses and it gets loose, it still can be used because unlike that in prior arts, in current invention gravity will make plugs contact automatically.

The third advantage it that USB outlet receptacles will also last longer. USB outlet receptacles are also located on one or multiple facing-up slope surfaces. Users can identify polarity much easier. There are less chances for users to use brutal force to plug in.

The fourth advantage is that there is less interference. In this embodiment of invention, power outlet receptacles are at outer part of housing while mobile devices support at inner part of housing.

The fifth advantage is that it is very easy to identify charging vacancy or available spots in a distance. Just like a bird can be easily to be seen at roof ridge or hip because of distinctive geometric shape and contrast.

The sixth advantage is that charging station in current invention can have very large capacity. It can simultaneously charge more than 40 mobile devices at a time.

The seventh advantage is that charging station in current invention is intended to be universal. It fit power plugs from most of countries. It can be sold and used globally by design.

The eighth advantage is that charging station in current invention itself is easily to be located and identified. Not only vacancies can be identified in a distance, but the charging stations themselves can also be identified. Shape of charging station can be made in shape of tree, tower or house that are culturally neutral. It is great convenient to users.

The tenth advantage is that charging efficiency is high. There is much less interference. There would be more users per charging station. Almost everybody nowadays has a mobile device and some even have multiple mobile devices. High charging efficiency is very important.

### SUMMARY OF THE INVENTION

By arranging power outlet receptacles on a facing-up slope surface and using multi-country compatible electrical power outlet receptacles, current invention solves problems that exist in prior arts and provides a reliable publicly accessible universal charging station for mobile phone, tablet, laptop and other portable devices. The charging station includes an electrical wire for power source, a main housing and multiple sets of device support and power outlet receptacles. Power outlet receptacles are through the combination geometry configuration outlets that are to electro-mechanically engage plugs with configurations for various major or even all countries in the world for global use. The receptacles are provided within the housing for receiving multiple mobile devices to be simultaneously charged. Every power outlet receptacle contact will be able to distribute power simultaneously. USB outlet receptacles can also be included. In use, the charging station would globally support utility from 110 VAC up to 240 VAC, 50 Hz or 60 Hz regular power source.

### BRIEF DESCRIPTION OF THE DRAWINGS

FIG. 1 is a perspective view of a universal mobile device charging station according to the present invention.

FIG. 2 shows that socket geometry of power outlet receptacles are configured to be simultaneously compatible with power plugs from various countries and that USB power outlet receptacles can also be added.

FIG. 3 is a front and side view of an embodiment of a universal mobile device charging station in shape of a tree.

FIG. 4 is a front and side view of another alternative embodiment of a universal mobile device charging station in shape of a tower.

### DETAILED DESCRIPTION OF THE PRESENT INVENTION

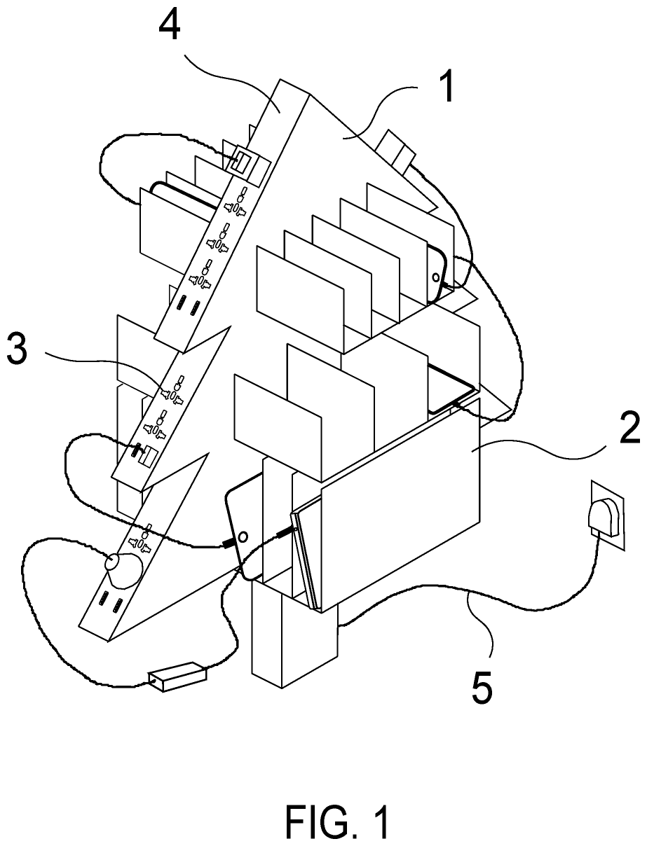

Referring to FIG. 1, it shows a perspective view of a universal mobile device charging station according to the present invention. It includes a housing 1, an electrical cord 5, multiple sets of mobile device supports 2, multiple power outlet receptacles 3. USB outlet receptacles 6 can be optional.

The charging station requires power outlet receptacles 3 are located on a facing-up slope surface 4. There are single or multiple facing-up slope surfaces 4 available at the charging station. Multiple mobile device supports are mounted at the housing 1. Mobile device supports 2 hold multiple mobile devices while the mobile devices are being charged.

Power source that the electrical cord 5 is lead to can be from 110 AC up to 240 AC depending on the installation country of the charging station. AC power frequency can be either 50 Hz or 60 Hz also depending on the installation country of the charging station. The charging station can charge mobile phone, tablets, laptop and other household or industrial electronics etc.

Power outlet receptacles 3 are at outer part of the charging station while mobile device supports 2 are in the middle section so that charging wire interference is minimal.

USB connector polarity at USB outlet receptacles 6 is easy to check and identify before users can plug in. Power outlet receptacles 3 are facing up while user electrical plugs insert in downwards so that even contacts of power outlet receptacles 3 are loose after longtime use, gravity can still hold electrical plugs to maintain required electrical contact.

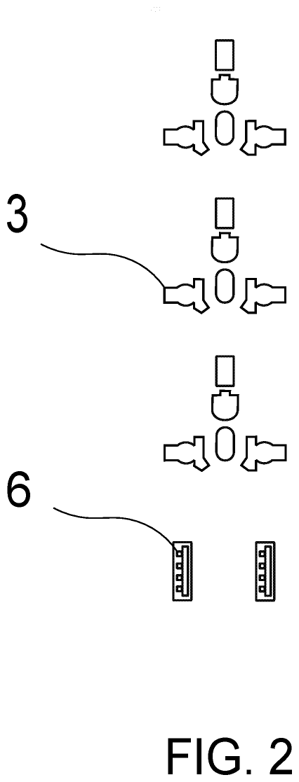

FIG. 2 shows an example of socket geometry configuration. Power outlet receptacles 3 are configured to be simultaneously compatible with power plugs from various countries. Mobile devices can be from any countries all over the world so socket configuration can be made even to support power plugs from all countries.

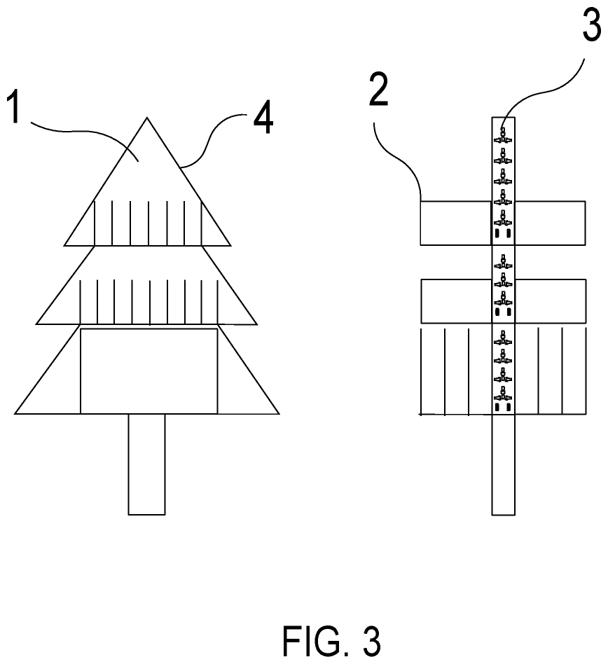

FIG. 3 is a front and side view of an embodiment of a universal mobile device charging station in profile shape of a tree. There is no standard shape of universal mobile device charging station so far. A tree shape is a good candidate for this standard. Tree shape is culturally neutral. It can be accepted and installed in any countries. Tree outline will automatically form a facing-up slope surface 4 so that power outlet receptacles 3 can installed at the facing-up slope surfaces 4. The charging stations in shape of a tree would have distinctive shape and would be easy to be located if people are looking for a public charging station.

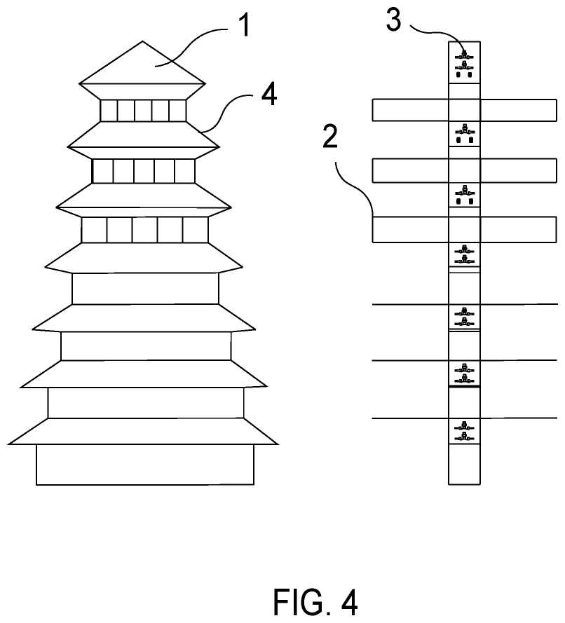

FIG. 4 is a front and side view of another embodiment of a universal mobile device charging station in profile shape of a tower. Of course, it can be also in shape of a house. A tower or a house would automatically have multiple facing-up slope surfaces 4 on the roof. Tower shape is also a good candidate for standard if there is no such standard so far.

People can particularly accept ideas that power can come from a facing-up slope surfaces 4 on a roof of a tower or a house due to the fact that nowadays solar power panels are on facing-up slope surface 4 at roof of residential houses. A tower or a house also has distinctive shape so that it is easy to be located if people are looking for public charging station. USB connector polarity at USB outlet receptacles 6 becomes easier to check and easier to identify before users can plug in.

It is to be understood that the present invention is not limited to the embodiments described above, but encompasses any and all embodiments within the scope of the following claims.

1. A universal mobile device charging station, comprising:
one or a plurality of facing-up slope surfaces with slope angles between 75 degrees and 15 degrees;
a housing having one or a plurality of said facing up slope surfaces;
an electrical cord at said housing leading to an AC power source that supplies electrical power for charging;
a plurality of mobile device supports mounted at said housing; and
a plurality of multi-country combination configuration power outlet receptacles on said facing up slope surfaces of said housing, wherein socket geometry of said power outlet receptacles is configured to be simultaneously compatible with power plugs from various countries and when said electrical cord is connected to an AC power source every said power outlet receptacle will be able to distribute power simultaneously.

2. A universal mobile device charging station, comprising:
one or a plurality of facing-up slope surfaces with slope angles between 75 degrees and 15 degrees;
a housing having one or a plurality of said facing up slope surfaces;
an electrical cord connected to said housing leading to an AC power source that supplies electrical power for charging;
a plurality of mobile device supports mounted at said housing;
a plurality of USB outlet receptacles on said facing up slope surfaces of said housing; and
a plurality of multi-country combination configuration power outlet receptacles on said facing up slope surfaces of said housing, wherein socket geometry of said power outlet receptacles is configured to be simultaneously compatible with power plugs from various countries and when said electrical cord is connected to an AC power source every said power outlet receptacle and USB outlet receptacle will be able to distribute power simultaneously.

3. A universal mobile device charging station, comprising:
one or a plurality of facing-up slope surfaces with slope angles between 75 degrees and 15 degrees;
a housing in shape of a tree having a plurality of said facing up slope surfaces;
an electrical cord at said housing leading to an AC power source that supplies electrical power for charging;
a plurality of mobile device supports mounted at said housing; and
a plurality of multi-country combination configuration power outlet receptacles on said facing-up slope surfaces of tree profile, wherein socket geometry of said power outlet receptacles is configured to be simultaneously compatible with power plugs from various countries and when said electrical cord is connected to an AC power source every said power outlet receptacle will be able to distribute power simultaneously.

4. A universal mobile device charging station, comprising:
one or a plurality of facing-up slope surfaces with slope angles between 75 degrees and 15 degrees;
a housing in shape of a tower or house having a plurality of said facing-up slope surfaces;
an electrical cord at said housing leading to an AC power source that supplies electrical power for charging;
a plurality of mobile device supports mounted at said housing; and
a plurality of multi-country combination configuration power outlet receptacles on said facing-up slope surfaces of tower or house roof, wherein socket geometry of said power outlet receptacles is configured to be simultaneously compatible with power plugs from various countries and when said electrical cord is connected to an AC power source every said power outlet receptacle will be able to distribute power simultaneously.
